(19) United States
(12) Patent Application Publication
(10) Pub. No.: US 2026/0235090 A1
(43) Pub. Date: Aug. 13, 2026

(54) MANIFOLD ASSEMBLY FOR A CLOSED-CYCLE ENGINE

(71) Applicant: Hyliion Holdings Corp, Cedar Park, TX (US)

(72) Inventors: Shroy S. Mukerjee, Cincinnati, OH (US); Jason Joseph Bellardi, Cincinnati, OH (US); Michael Robert Notarnicola, Cincinnati, OH (US); Aigbedion Akwara, Cincinnati, OH (US)

(21) Appl. No.: 19/052,374

(22) Filed: Feb. 13, 2025

(51) Int. Cl. F02G 1/053; F02G 1/044; F02G 1/05

(52) U.S. Cl. CPC F02G 1/053; F02G 1/044; F02G 1/05; F02G 2244/52; F02G 2244/54

(57) ABSTRACT

An engine assembly may include a first closed-cycle engine including a first piston assembly and a second closed-cycle engine including a second piston assembly. A manifold assembly may be configured to operably couple with the first closed-cycle engine and the second closed-cycle engine. The manifold assembly may include a housing. A first conduit may be positioned within the housing. The first conduit may be configured to direct a fluid from the first piston assembly to the second piston assembly. A pressure control system may be within the first conduit and configured to allow fluid flow in a defined direction.

### FIELD OF THE INVENTION

The present disclosure relates generally to vehicles having a closed-cycle engine, and more particularly to a manifold assembly for a closed-cycle engine.

### BACKGROUND OF THE INVENTION

Large, wheeled vehicles pull trailers to transport large volumes of cargo. In some cases, the vehicle and trailer, in combination, may weigh upwards of 140,000 pounds for a tandem-loaded trailer. In a traditional vehicle with an internal combustion engine, the internal combustion engine may be quite large (e.g., up to fifteen liters) to provide enough power to propel the vehicle and the trailer.

Accordingly, large vehicles capable of integrating various power plants, such as a closed-cycle engine, that may allow for alternative power to be used to operate the large vehicle would be welcomed in the technology.

### BRIEF DESCRIPTION OF THE DRAWINGS

A full and enabling disclosure of the present disclosure, including the best mode thereof, directed to one of ordinary skill in the art, is set forth in the specification, which makes reference to the appended figures, in which:

FIG. 1 illustrates a side view of a wheeled vehicle capable of transporting cargo over an extended range in accordance with aspects of the present subject matter;

FIG. 2 illustrates a detailed, top view of a wheeled vehicle capable of transporting cargo over an extended range in accordance with aspects of the present subject matter;

FIG. 3 illustrates a perspective view of a closed-cycle engine for a vehicle in accordance with aspects of the present subject matter;

FIG. 4 illustrates a cross-sectional view of one of the closed-cycle engines taken along the line IV-IV of FIG. 3 in accordance with aspects of the present subject matter;

FIG. 5 is a schematic diagram of a plurality of an engine assembly in accordance with aspects of the present subject matter;

FIG. 6 illustrates a perspective view of a manifold assembly in accordance with aspects of the present subject matter;

FIG. 7 illustrates a perspective view of a manifold assembly in accordance with aspects of the present subject matter;

FIG. 8 illustrates a top plan view of a manifold assembly in accordance with aspects of the present subject matter;

FIG. 9 illustrates a bottom plan view of a manifold assembly in accordance with aspects of the present subject matter;

FIG. 10 is a cross-sectional view taken along the line X-X of FIG. 8;

FIG. 11 is a cross-sectional view taken along the line XI-XI of FIG. 8;

FIG. 12 is a cross-sectional view taken along the line XII-XII of FIG. 8;

FIG. 13 is a cross-sectional view taken along the line XIII-XIII of FIG. 8;

FIG. 14 is a cross-sectional view taken along the line XIV-XIV of FIG. 10;

FIG. 15 is a cross-sectional view taken along the line XV-XV of FIG. 10;

FIG. 16 is a cross-sectional view taken along the line XVI-XVI of FIG. 10;

FIG. 17 illustrates a perspective view of a manifold assembly in accordance with aspects of the present subject matter;

FIG. 18 illustrates a perspective view of a manifold assembly in accordance with aspects of the present subject matter;

FIG. 19 illustrates an engine assembly including four closed-loop engines operably coupled with the manifold assembly in accordance with aspects of the present subject matter;

FIG. 20 illustrates the engine assembly of FIG. 19 with one of the four closed-loop engines operably coupled with the manifold assembly removed in accordance with aspects of the present subject matter; and

FIG. 21 is a flow diagram of a method for operating a closed-cycle engine in accordance with aspects of the present subject matter Repeat use of reference characters in the present specification and drawings is intended to represent the same or analogous features or elements of the present technology.

### DETAILED DESCRIPTION OF THE INVENTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations may be made in the present disclosure without departing from the scope or spirit of the disclosure. For instance, features illustrated or described as part may be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to a fluid within a fluid circuit. For example, “upstream” refers to the direction from which a fluid flows, and “downstream” refers to the direction to which the fluid moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality may be seen as “associated with” each other such that the desired functionality is achieved, irrespective of architectures or intermedial components. Likewise, any two components so associated may also be viewed as being “operably connected” or “operably coupled” to each other to achieve the desired functionality, and any two components capable of being so associated may also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items may be employed by itself, or any combination of two or more of the listed items may be employed. For example, if a composition or assembly is described as containing components A, B, and/or C, the composition or assembly may contain A alone; B alone; C alone; A and B in combination; A and C in combination; B and C in combination; or A, B, and C in combination.

In general, the present disclosure is directed to a closed-cycle engine that may include an engine assembly that may include a first closed-cycle engine including a first piston assembly and a second closed-cycle engine including a second piston assembly. A manifold assembly may be configured to operably couple with the first closed-cycle engine and the second closed-cycle engine.

The manifold assembly may include a housing and a first conduit positioned within the housing. The first conduit may be configured to direct a fluid from the first piston assembly to the second piston assembly. In some instances, a pressure control system may be positioned within the first conduit and configured to allow fluid flow in a defined direction.

In various examples, a cooling system may include a coolant source. Moreover, a first channel may be configured to transfer coolant from the coolant source to the first closed-cycle engine. In addition, a second channel may be configured to transfer coolant from the first closed-cycle engine to the coolant source. Additionally or alternatively, the manifold assembly may further include a pressure sensor positioned within the conduit and/or any other portion of the housing and configured to detect data indicative of a pressure within the first piston assembly. As such, the manifold assembly may be configured to operably couple one or more closed-loop engines to one another, transfer fluid between the closed-loop engines, regulate the fluid between the two closed-loop engines, transfer a coolant through the housing and/or through one or more closed-loop engines, and/or monitor a pressure within the one or more closed-loop engines.

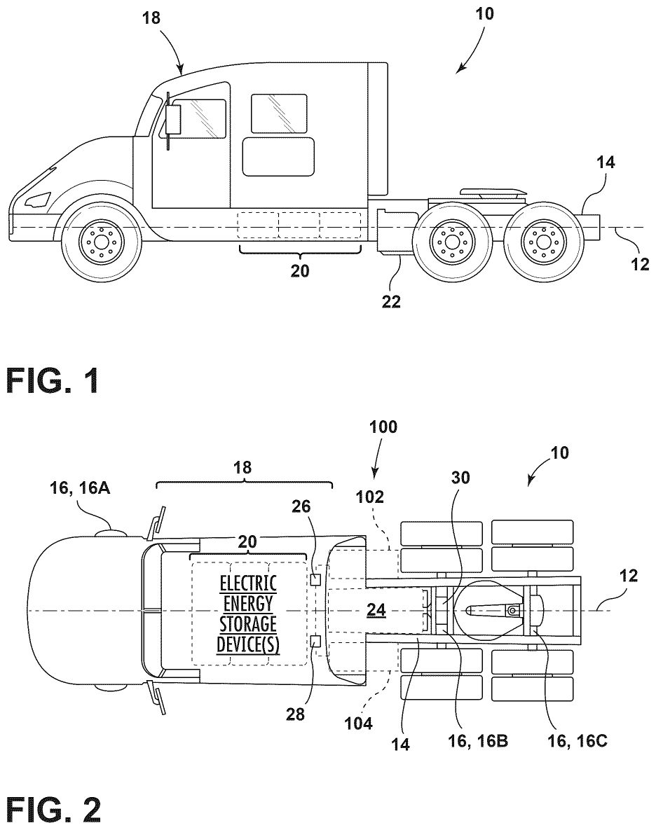

Referring now to the drawings, FIGS. 1 and 2 illustrate various views of a wheeled vehicle 10 along a fore/aft axis 12 according to the present disclosure. As shown generally in FIGS. 1 and 2, the vehicle 10 may include a chassis 14, which may support multiple axles 16 and/or a cab 18. The one or more axles 16 may be operably coupled to the chassis 14. In some instances, the one or more axles 16 may include a front axle 16A and a pair of rear axles 16B, 16C.

Additionally, the vehicle 10 may include an engine assembly 100 that may include one or more closed-cycle engines 102, an array of energy storage devices 20 (e.g., batteries), and/or a motor/generator 22 coupled to at least one of the axles 16. Moreover, the vehicle 10 may include one or more fuel tanks 24 operably coupled with the one or more closed-cycle engines 102.

Furthermore, the vehicle 10 may be equipped with one or more power converters 26, 28 coupled to the closed-cycle engines 102 and the array of energy storage devices 20. In some cases, an array of energy storage devices 20 may be positioned in various locations on the vehicle 10. For instance, the energy storage devices 20 may be located between the rails of the chassis 14, under the rails of the chassis 14, around the rails of the chassis 14, and/or in any other practicable location. Moreover, the array of energy storage devices 20 may be connected in series, parallel, and/or some combination. In operation, electric power generated by the motor/generator 22 may be used to charge the array of energy storage devices 20.

With further reference to FIGS. 1 and 2, the motor/generator 22 may be coupled to at least one of the axles 16. For example, in some instances, the motor/generator 22 may be integrated with one of the axles 16 as an e-axle configuration or located in a hub of a wheel coupled to one of the axles 16 as a hub motor/generator configuration. Additionally or alternatively, the motor/generator 22 may be operably coupled to gearboxes or differentials of the vehicle 10. For example, the motor/generator 22 may be coupled to a three-speed centralized gearbox 30 with a two-speed rear differential 38 to provide six discrete gear ratios. In some examples, the vehicle 10 may be configured with a plurality of motors/generators 22, with a respective motor/generator 22 coupled to each wheel or pair of wheels.

While the closed-cycle engines 102 are used to power the vehicle 10 in FIGS. 1 and 2, it will be appreciated that the closed-cycle engines 102 may be used to generate mechanical energy for any other purpose without departing from the scope of the present disclosure.

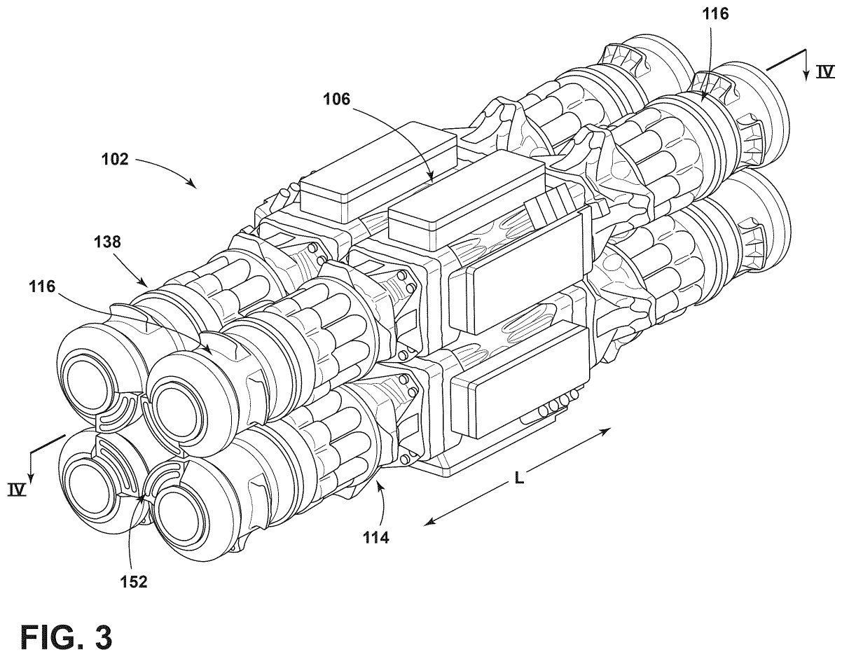

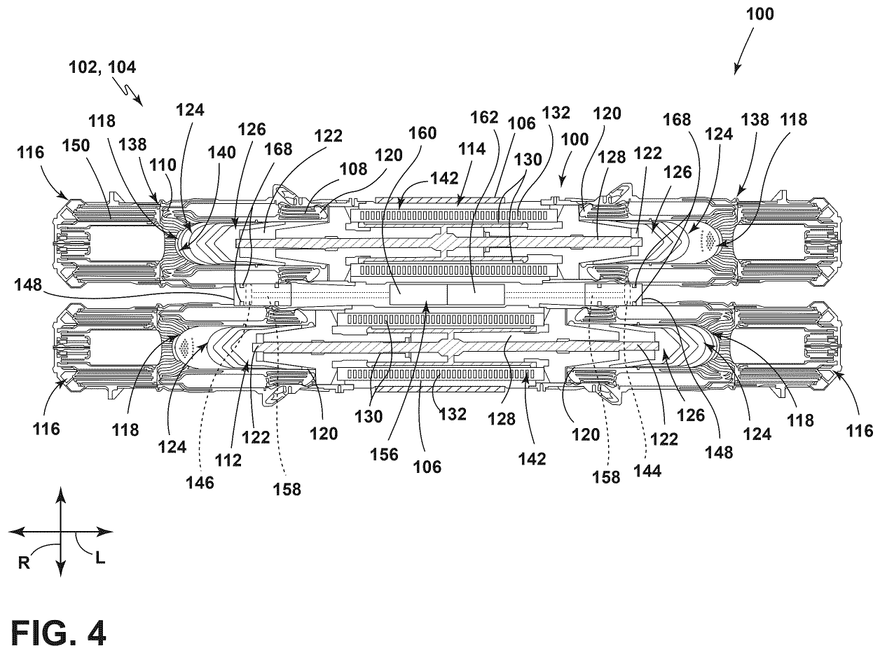

Referring now to FIGS. 3 and 4, the closed-cycle engines 102 capable of being operably coupled to a load device 106 are illustrated according to various aspects of the present disclosure. The closed-cycle engine 102 may contain an engine working fluid to which and from which thermal energy is exchanged at a respective cold side heat exchanger 108 and a hot side heat exchanger 110. In various instances, any suitable engine working fluid may be utilized in accordance with the present disclosure. In various cases, the working fluids may be inert, such that they generally do not participate in chemical reactions such as oxidation within the environment of the closed-cycle engine 102. For example, the engine working fluid may include a gas, such as a noble gas as the engine working fluid. Various noble gasses that may be utilized by the closed-cycle engine 102 may include monoatomic gases, such as helium, neon, argon, krypton, or xenon, as well as combinations of these. In several examples, the engine working fluid may include air, oxygen, nitrogen, hydrogen, carbon dioxide, any other practicable fluid, as well as combinations of these. In still various instances, the engine working fluid may be liquid fluids of one or more elements described herein, or combinations thereof. It will be appreciated that various examples of the engine working fluid may include particles or other substances as appropriate for the engine working fluid.

In various cases, the load device 106 may be a mechanical work device and/or an electric machine. For example, the load device 106 may be a pump, compressor, or other work device. Additionally or alternatively, the load device 106 may be an electric machine that is configured as a generator to produce electric energy from the movement of a piston assembly 112 of the closed-cycle engine 102. In still another example, the electric machine may be configured as a motor that may provide motive force to move or actuate the piston assembly 112, such as to provide initial movement (e.g., a starter motor). In still various examples, the electric machine may be configured as a motor and generator or another electric machine.

As illustrated in FIGS. 3 and 4, the closed-cycle engine 102 may include an engine body 114 and a pair of housings 116 disposed on opposing sides of the engine body 114. For example, a first housing 116 may be disposed at a first side portion of the engine body 114 and a second housing 116 may be disposed at a second side portion of the engine body 114. In still other examples, a plurality of engine bodies 114 may be provided, and/or a single housing 116 or a multitude of housings 116 may be provided.

In various embodiments, as shown in FIG. 4, the hot side heat exchanger 110 may output thermal energy to the engine working fluid at an expansion chamber 118 of the closed-cycle engine 102. The hot side heat exchanger 110 may be positioned proximate to the expansion chamber 118 of the engine in thermal communication with the housing 116. In other examples, the hot side heat exchanger 110 may be separate from the housing 116, such that the heating working fluid is provided in thermal communication, or additionally, in fluid communication with the hot side heat exchanger 110. In some cases, the hot side heat exchanger 110 may be positioned in thermal communication with the housing 116 and the expansion chamber 118 of the engine 102 such as to receive thermal energy from the housing 116 and provide thermal energy to the engine working fluid within the closed-cycle engine 102.

In still various examples, the housing 116 may include a single thermal energy output source to a single expansion chamber 118 of the engine. As such, the closed-cycle engine 102 may include a plurality of heater assemblies each providing thermal energy to the engine working fluid at each expansion chamber 118. In other embodiments, such as depicted in regard to FIG. 4, the housing 116 may provide thermal energy to a plurality of expansion chambers 118 of the closed-cycle engine 102.

The closed-cycle engine 102 may further include a chiller assembly 120. The chiller assembly 120 may be configured to receive and displace thermal energy from a compression chamber 122 of the closed-cycle engine 102. Additionally, the cold side heat exchanger 108 may be thermally coupled to the compression chamber 122 of the closed-cycle engine 102, and the chiller assembly 120. In some instances, the cold side heat exchanger 108 and a piston chamber 126 defining the compression chamber 122 of the closed-cycle engine 102 may together be defined as an integral, unitary structure. In still various examples, the cold side heat exchanger 108, at least a portion of the piston chamber 126 defining the compression chamber 122, and at least a portion of the chiller assembly 120 may together define an integral, unitary structure.

In various embodiments, as shown in FIG. 4, the chiller assembly 120 may be a bottoming cycle to the closed-cycle engine 102. As such, the chiller assembly 120 may be configured to receive thermal energy from the closed-cycle engine 102. The thermal energy received at the chiller assembly 120, such as through a cold side heat exchanger 108, may be added to a chiller working fluid at the chiller assembly 120. In various examples, the chiller assembly 120 defines a Rankine cycle system through which the chiller working fluid flows in a closed loop arrangement with a compressor. In some examples, the chiller working fluid may be in a closed-loop arrangement with an expander. In various cases, the cold side heat exchanger 108 may include a condenser or radiator. The cold side heat exchanger 108 may be positioned downstream of the compressor and upstream of the expander and in thermal communication with the compression chamber 122 of the closed-cycle engine 102. In various embodiments, the cold side heat exchanger 108 may generally define an evaporator receiving thermal energy from the closed-cycle engine 102.

Referring still to FIG. 4, each piston assembly 112 may be positioned within a volume or piston chamber 126. The volume within the piston chamber 126 is separated into a first chamber, or hot chamber, or expansion chamber 118 and a second chamber, or cold chamber (relative to the hot chamber), or compression chamber 122 by a piston 124 of the piston assembly 112. The expansion chamber 118 may be positioned thermally proximally to the housing 116 relative to the compression chamber 122 thermally distal to the housing 116. The compression chamber 122 may be positioned thermally proximal to the chiller assembly 120 relative to the expansion chamber 118 thermally distal to the chiller assembly 120.

In various instances, the piston assembly 112 may be configured as a double-ended piston assembly 112 in which a pair of pistons 124 is each coupled to a connection member 128. The connection member 128 may generally define a rigid shaft or rod extended along a direction of motion of the piston assembly 112. In other instances, the connection members 128 may include one or more springs or spring assemblies, such as further provided herein, providing flexible or non-rigid movement of the connection member 128. In still other instances, the connection member 128 may further define substantially U-shaped connections or V-shaped connections between the pair of pistons 124.

Each piston 124 may be positioned within the piston chamber 126 such as to define the expansion chamber 118 and the compression chamber 122 within the volume of the piston chamber 126. In operation, combustion may occur within a first combustion chamber 118 housing the first piston 124 causing the first piston 124, the connection member 128, and the second position 124 to move from a first position to a second position in a lateral L direction. In turn, combustion may occur within a second combustion chamber 118 housing the second piston 124 causing the first piston 124, the connection member 128, and the second piston 124 to move from the second position to the first position. The load device 106 may be operably coupled to the piston assembly 112 such as to extract energy therefrom, provide energy thereto, or both. The load device 106 may define an electric machine that is in magnetic communication with the closed-cycle engine 102 via the connection member 128. In various examples, the piston assembly 112 may include a load member 130 positioned in operable communication with a stator assembly 132 of the electric machine. The stator assembly 132 may generally include a magnet array and a plurality of windings wrapped circumferentially relative to the piston assembly 112 and extended along a lateral direction L. In some instances, such as depicted in regard to FIG. 4, the load member 130 is connected to the connection member 128. In some examples, the linear motion of the load member 130 in conjunction with the piston assembly 112 may generate electricity via the magnetic communication between the stator assembly 132 and the load member 130.

Referring still to FIG. 4, in various embodiments, the hot side heat exchanger 110 may further define at least a portion of the expansion chamber 118. In some cases, the hot side heat exchanger 110 defines a unitary or monolithic structure with at least a portion of the piston chamber 126, such as to define at least a portion of the expansion chamber 118. In some embodiments, the housing 116 may further define at least a portion of the hot side heat exchanger 110, such as to define a unitary or monolithic structure with the hot side heat exchanger 110.

Furthermore, as shown in FIGS. 3 and 4, the piston chamber 126 may define a dome structure 140 within the expansion chamber 118. The expansion chamber dome structure 140 may provide reduced surface area heat losses across the outer end segment of the expansion chamber 118. In various instances, the pistons 124 of the piston assembly 112 may also include domed pistons 124 corresponding to the expansion chamber dome structure 140. The dome structure 140, the piston 124, or both may provide higher compression ratios at the chambers 122, such as to improve power density and output.

Various examples of the closed-cycle engine 102 may include control systems and methods of controlling various sub-systems disclosed herein, such as, but not limited to, the fuel source, the oxidizer source, the cooling fluid source, the housing 116, the chiller assembly 120, and the load device 106, including any flow rates, pressures, temperatures, loads, discharges, frequencies, amplitudes, or other suitable control properties associated with the closed-cycle engine 102.

In some examples, the control system may control the closed-cycle engine 102 to generate a temperature differential, such as a temperature differential at the engine working fluid relative to the heating working fluid and the chiller working fluid. Thus, the closed-cycle engine 102 defines a hot side, such as at the expansion chamber 118, and a cold side, such as at the compression chamber 122. The temperature differential causes free piston assemblies 112 to move within their respective piston chambers defined at respective piston chambers 126. The movement of pistons 124 within the respective piston chambers 126 causes the electric machine to generate electrical power. The generated electrical power may be provided to the energy storage devices 20. The control system may monitor one or more operating conditions associated with the closed-cycle engine 102, such as piston movement (e.g., amplitude and position), as well as one or more operating conditions associated with the electric machine, such as voltage or electric current. Based on such conditions, the control system generates control commands that are provided to one or more controllable devices of the closed-cycle engine 102. The controllable devices execute control actions in accordance with the control commands.

In various examples, such as the one shown in FIG. 4, the load device 106 may include a machine body 142 positioned laterally between the piston chambers 126. The machine body 142 surrounds and houses the stator assembly 132 of the load device 106 defining the electric machine. The machine body 142 may further surround the load member 130 of the electric machine attached to the connection member 128 of the piston assembly 112.

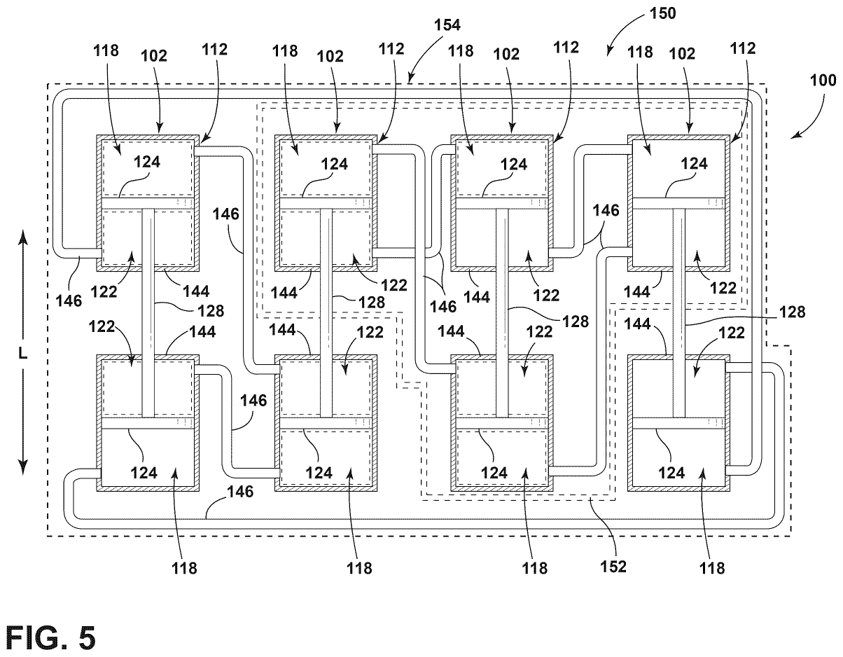

Referring further to FIGS. 4 and 5, a manifold assembly 148 may be operably coupled with one or more of the closed-cycle engine 102. In various examples, the manifold assembly 148 may be configured to operably coupled with each of the closed-cycle engines 102 thereby maintaining a position of each respective closed-cycle engine 102 relative to one another.

In various examples, the closed-cycle engines 102 may be in a siemens configuration and/or otherwise share fluid (e.g., gas and/or any other fluid) between the closed-cycle engines 102. In some examples, the manifold assembly 148 may define one or more conduits 146 for directing gas and fluid volumes from one of the closed-cycle engines 102 to another one of the closed-cycle engines 102 (or from one portion of the closed-cycle engine 102 to another portion of the closed-cycle engine 102).

With further reference to FIG. 5, the engine assembly 100 may include a plurality of closed-cycle engines 102. Each of the closed-cycle engines 102 may include a piston assembly 112 fluidly coupled to a piston assembly 112 of another one of the closed-cycle engines 102 in balanced pressure and/or balanced phase arrangement. In various examples, the piston assembly 112 includes a pair of pistons 124 attached to one another via a connection member 128. In still various examples, the piston assemblies 112 can operate in balanced pressure and/or balanced phase relationship while being mechanically independent of one another. For example, the engine assembly 100 may include camshafts, crankshafts, rocker arms, or other mechanical linkages coupling two or more of the piston assemblies. In other instances, the piston assembly 112 may include a linkage coupling of two or more piston assemblies in a balanced pressure and/or balanced phase arrangement.

The piston 124 of the piston assembly 112 may be surrounded by a piston body 144. In various embodiments, the piston body 144 defines a first, expansion chamber 118, a hot chamber, or the first localized fluid volume within the piston body 144 at one side of the piston 124. The expansion chamber 118 may be positioned in thermal communication with a heat source, such as to provide heat or thermal energy into the expansion chamber 118. The piston body 144 may further define a second, compression chamber 122, a cold chamber, or a second localized fluid volume within the piston body 144 at another side of the piston 124. The compression chamber 122 may be positioned in thermal communication with a heat sink, such as to remove thermal energy or heat from the compression chamber 122. A plurality of conduits 146 may fluidly connect the expansion chamber 118 of one piston assembly 112 and the compression chamber 122 of another piston assembly 112. A portion of the expansion chambers 118 and the compression chambers 122 may be contained within an interconnected volume 150.

A first plurality of chambers, such as depicted within interconnected volume 150, includes a first plurality of the expansion chambers 118 and a first plurality of the compression chambers 122 within the interconnected volume 150 fluidly separate and/or pneumatically separate from a second plurality of chambers including the expansion chamber 118 and the compression chamber 122 outside of the interconnected volume 150. In some examples, the first plurality of expansion chambers 118 is depicted within a first interconnected volume 152. The first interconnected volume 152 of chambers 118, 122 may include the first plurality of expansion chambers 118 and the first plurality of compression chambers 122 fluidly separate and/or pneumatically separate from the second plurality of first chambers and second chambers outside of the first interconnected volume 152, such as depicted within the second interconnected volume 154.

Stated differently, pressure waves or motive forces formed within the plurality of chambers forming the interconnected volume 150 by the movement of one piston assembly 112 are mitigated from propagating to another piston assembly 112. Stated still differently, pressure waves or motive forces formed outside of the plurality of chambers forming the interconnected volume 150 by the movement of one piston assembly 112 are mitigated from propagating to another piston assembly 112. In several examples, the interconnected volume 150 of the plurality of chambers may separate pressure wave propagation and motive forces developed outside of the interconnected volume 150 from acting upon the one or more pistons 124 within the interconnected volume 150 of chambers. Additionally, or alternatively, the interconnected volume 150 may separate pressure wave propagation and motive forces developed within the interconnected volume 150 of expansion chambers 118 and compression chambers 122 from acting upon the one or more pistons 124 outside of the interconnected volume 150 In various examples, the portion of the plurality of conduits 146 fluidly connects the expansion chamber 118 of one piston assembly 112 and the compression chamber 122 of another piston assembly 112 into an interconnected volume 150. The interconnected volume 150 defines a fluid interconnection of the expansion chamber 118 and the compression chamber 122 at different piston assemblies 112 such that a fluid communication or fluid leakage path between the expansion chamber 118 and the compression chamber 122 of the same piston 124 provides a single fluid loop separated from the fluidly connected chambers 118, 122 outside of the interconnected volume 150. In some instances, the balanced pressure arrangement and/or the balance phase arrangement of the piston assemblies 112 is the fluid interconnection of the conduits 146 and chambers 118, 122 such that the chambers 118, 122 within the interconnected volume 150 are substantially fluidly separate and/or pneumatically separate from those chambers 118, 122 outside of the interconnected volume 150 to provide a substantially equal and opposite force relative to one another to at least one piston assembly 112 when the engine working fluid within the chambers 118, 122, which may be at a uniform temperature. In various embodiments, the engine assembly 100 includes a plurality of interconnected volumes 150, such as a first interconnected volume 152 fluidly separate and pneumatically separate from a second interconnected volume 154.

The arrangement of the interconnected volume 150, or plurality thereof, may mitigate pressure propagation across the plurality of piston assemblies 112 such that the movement of adjacent piston assemblies may not be driven by mechanical forces. Stated differently, the arrangement of the chambers 118, 122 within the interconnected volume 150 relative to chambers outside of the interconnected volume 150 provides for the movement of one piston assembly 112 of the interconnected volume 150 to induce an equal and opposite force at an adjacent piston assembly 112 in fluid contact with the piston assembly 112 outside of the interconnected volume 150. Alternatively, the arrangement of chambers 118, 122 within the first interconnected volume 152 relative to chambers within the second interconnected volume 154 provides for the movement of one piston assembly 112 at one interconnected volume to induce an equal and opposite force at an adjacent piston assembly 112 at another interconnected volume.

Referring back to FIGS. 4 and 5, in various examples, the manifold assembly 148 may further include a cooling system 156. For instance, in some examples, the manifold assembly 148 may define one or more channels 158 through which a coolant of the cooling system 156 may flow. In several examples, the cooling system 156 may further include a coolant source 160 and a pump 162 for circulating a coolant through the manifold assembly 148. In some instances, the pump 162 may be integrated with the engine assembly 100 or as a stand-alone component electrically powered by the engine assembly 100 and/or any other power source.

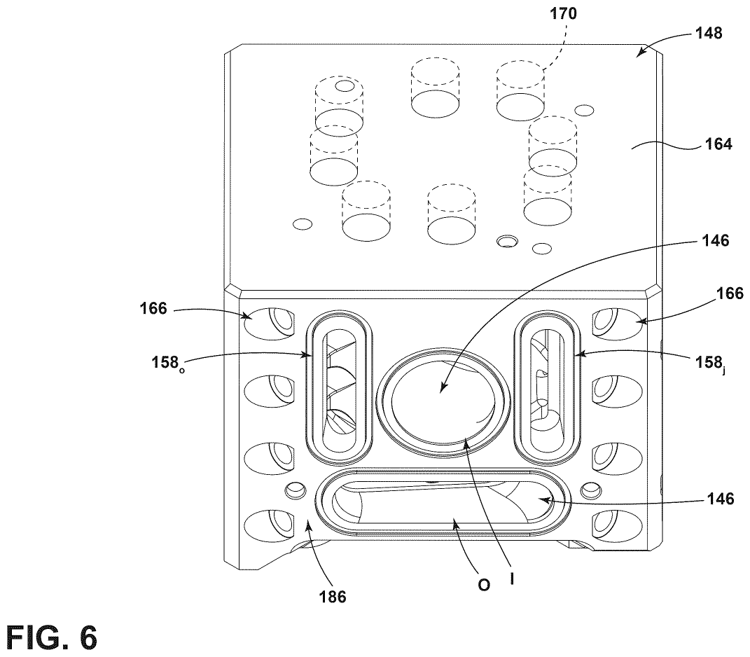

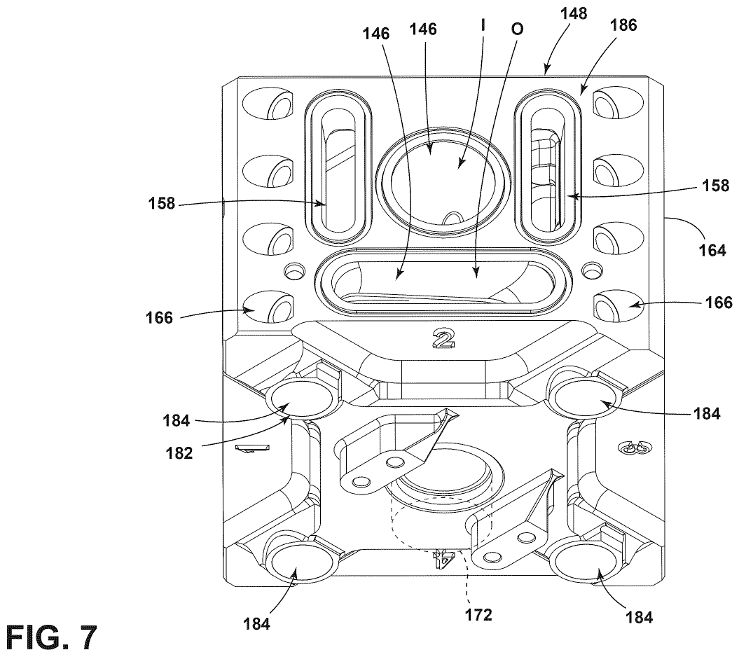

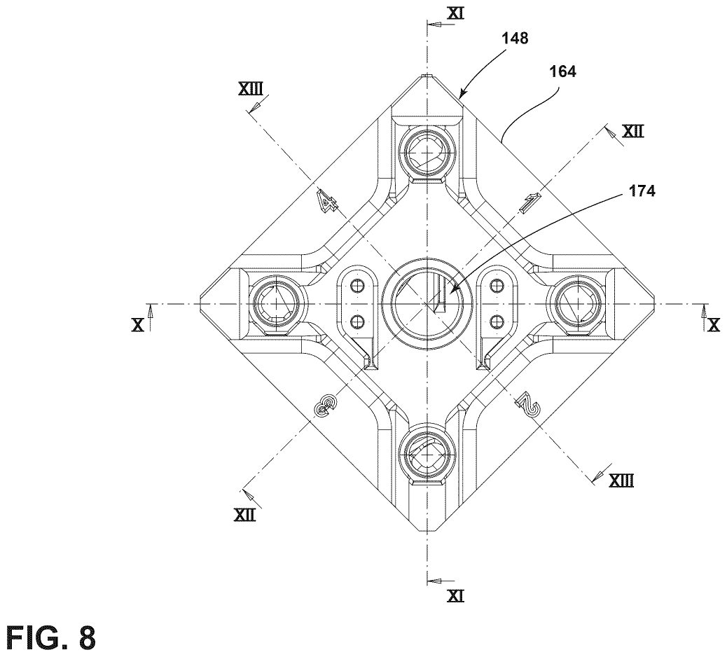

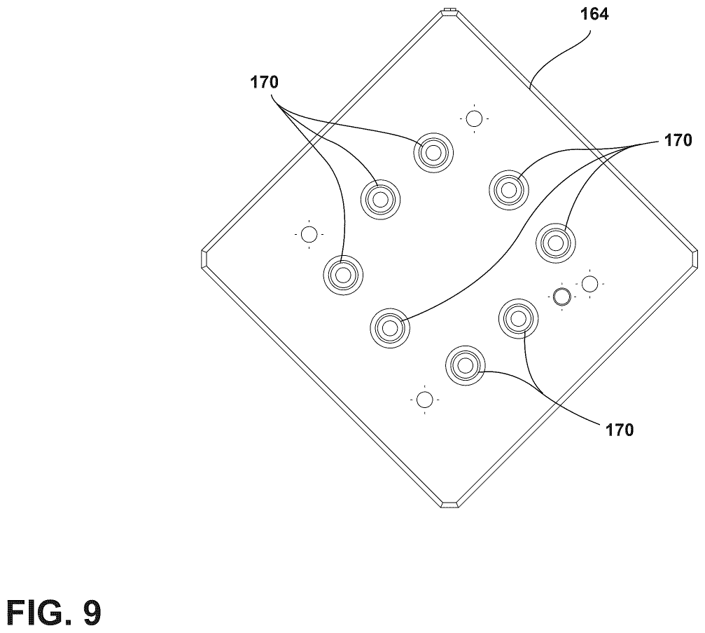

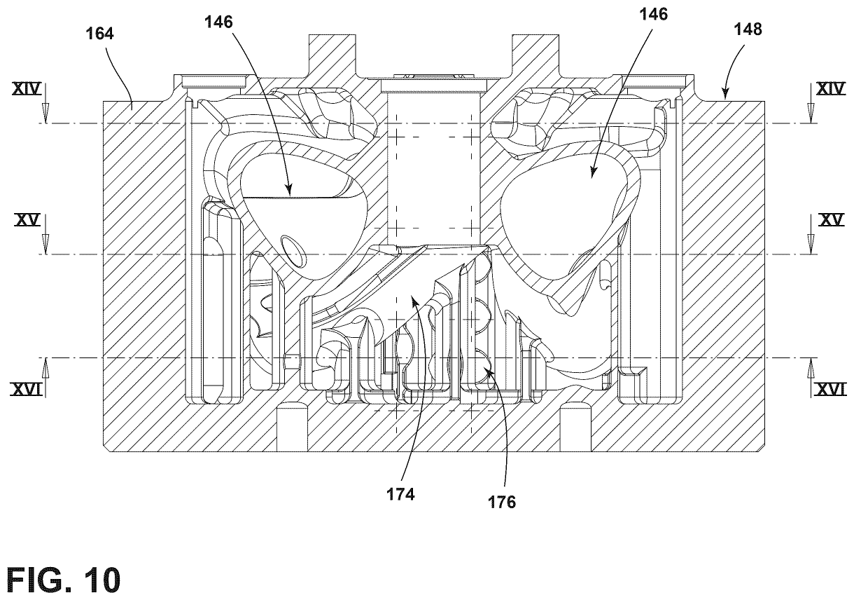

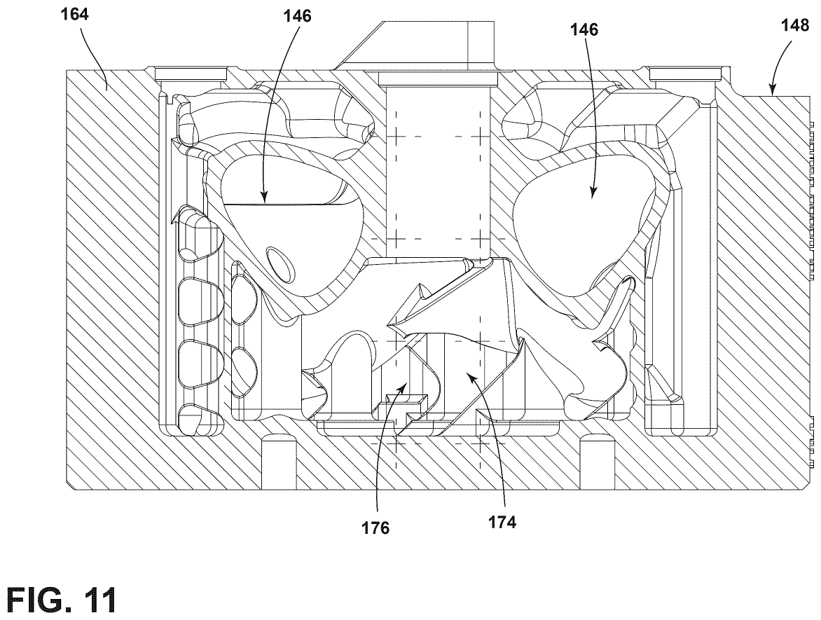

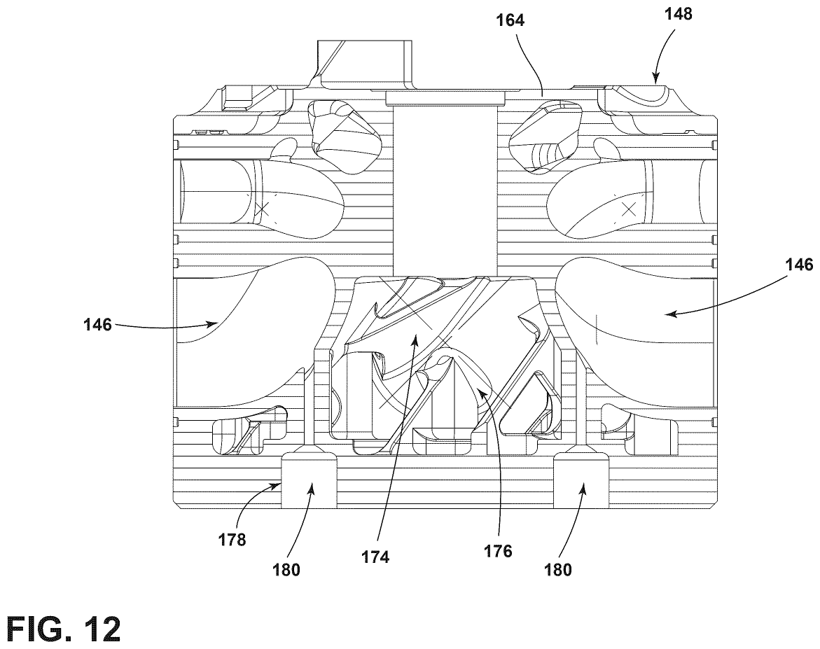

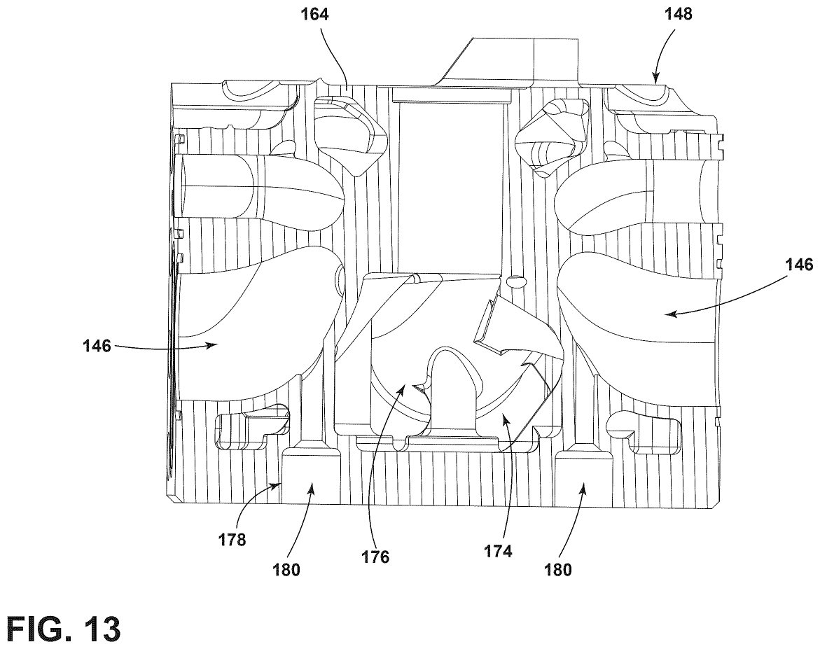

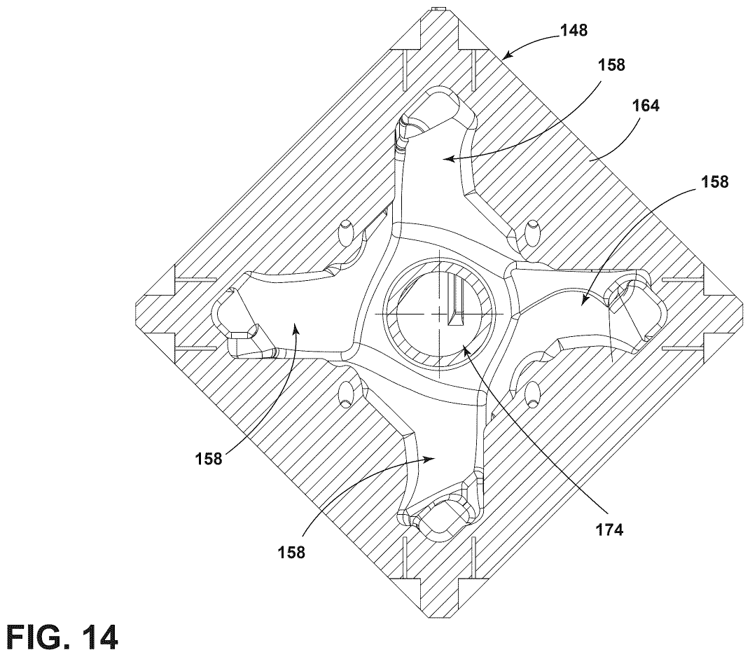

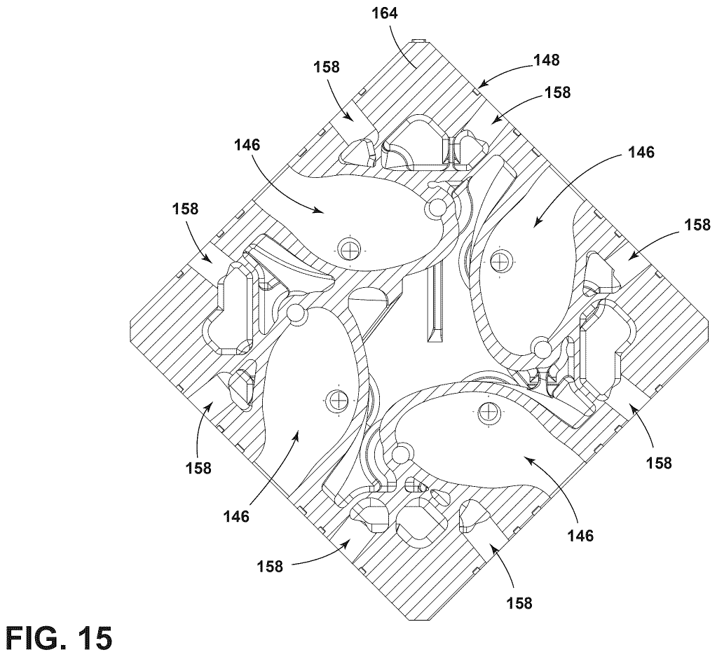

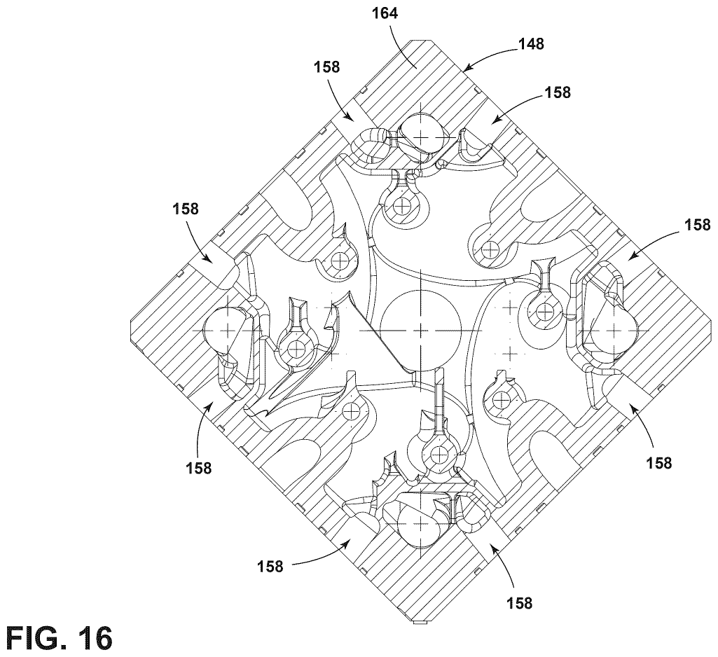

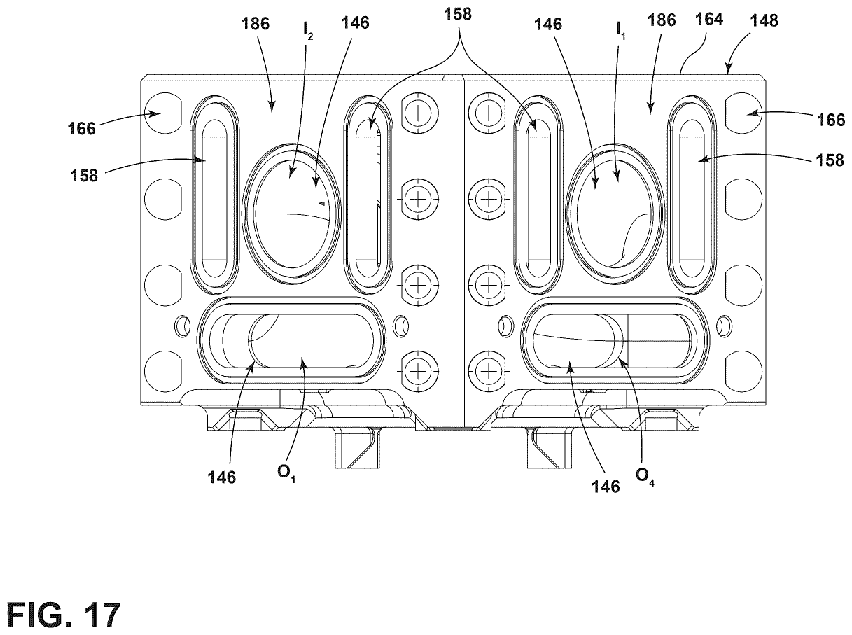

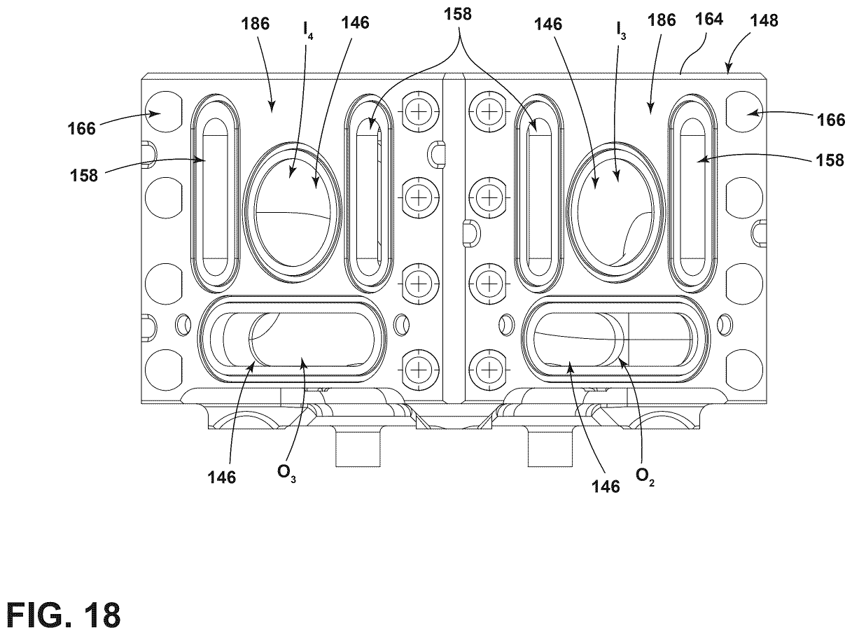

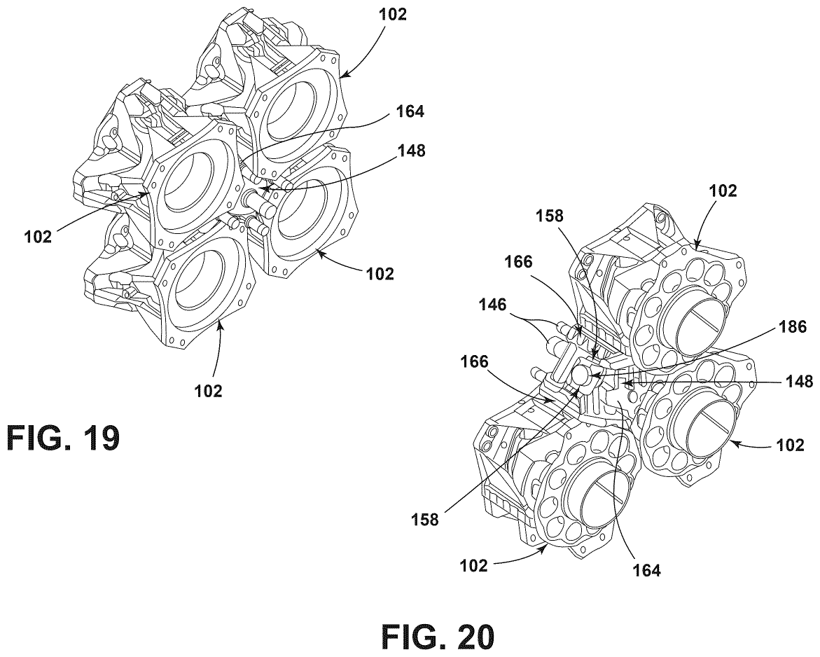

Referring now to FIGS. 6-20, in various examples, the manifold assembly 148 may include a housing 164 that is configured to operably couple with one or more closed-cycle engines 102. In various examples, the housing 164 may be an integral component that is formed through any manufacturing process, such as an additive manufacturing process. Alternatively, the housing 164 may be comprised of more than one component that is each formed through any practicable manufacturing process.

As illustrated, the housing 164 may include one or more coupling portions 166 that are configured to communicate with one or more closed-cycle engines 102. For example, in instances in which the manifold assembly 148 is configured to operably couple with four closed-cycle engines 102, the housing 164 may include eight coupling portions 166 such that a pair of coupling portions 166 are configured to communicate with each of the closed-cycle engines 102. As shown, each coupling portion 166 may include one or more fastener voids that are defined by the housing 164. Respective fastener holes 168 may be defined by the one or more closed-cycle engines 102. As such, a fastener may be inserted through both when the one or more fastener voids of the housing 164 are aligned with the respective fastener holes 168 to operably couple the manifold assembly 148 with each of the one or more closed-cycle engines 102. However, in other examples, the coupling portions 166 may be configured in any other manner and/or include any other component for operably coupling the manifold assembly 148 to the one or more closed-cycle engines 102.

With further reference to FIGS. 6-20, the housing 164 may also define or include one or more conduits 146 for directing a fluid from one closed-loop engine 102 to another closed-loop engine (and/or from one portion of a closed-loop engine 102 to another portion of the closed-loop engine 102). For example, the housing 164 may include a plurality of conduits 146 that are configured to fluidly interconnect the expansion chamber 118 of one piston assembly 112 with the compression chamber 122 of a second piston assembly 112. In such examples, each conduit 146 may define an inlet portion I for receiving the fluid from a first expansion chamber 118 or compression chamber 122 and an outlet portion O for directing the fluid from the first expansion chamber 118 or a first compression chamber 122 to a second compression chamber 122 or a second expansion chamber 118. As illustrated, the inlet portion I may define a first cross-sectional geometric shape and/or a first cross-sectional area, and the outlet portion O may define a second cross-sectional geometric shape and/or a second cross-sectional area. As shown, the first cross-sectional geometric shape may be varied from the second cross-sectional geometric shape. Alternatively, the first cross-sectional geometric shape may be common with the second cross-sectional geometric shape. Additionally or alternatively the first cross-sectional area may be varied in size from the second cross-sectional area. For example, the first cross-sectional area may be larger than or less than the second cross-sectional area. Alternatively, the first cross-sectional area may be equal to the second cross-sectional area.

Referring still to FIGS. 6-20, the housing 164 may also define or include one or more channels 158 for directing a coolant to one closed-loop engine 102, from one closed-loop engine 102 to another closed-loop engine (and/or from one portion of a closed-loop engine 102 to another portion of the closed-loop engine 102). Additionally or alternatively, the one or more channels 158 may be configured to thermally couple with the one or more conduits 146 within the housing 164. In such examples, a first set of the channels 158 may be configured as inlet channels 158; for receiving the coolant from one or more supply lines 170, and a second set of the channels 158 may be configured as outlet channels 1580 for directing the coolant to one or more return lines 172. As illustrated, the inlet channels 158; may define a first cross-sectional geometric shape and/or a first cross-sectional area and the outlet channels 1580 may define a second cross-sectional geometric shape and/or a second cross-sectional area. As shown, the first cross-sectional geometric shape may be common with the second cross-sectional geometric shape. Alternatively, the first cross-sectional geometric shape may be common with the second cross-sectional geometric shape. Additionally or alternatively the first cross-sectional area may be varied in size from the second cross-sectional area. For example, the first cross-sectional area may be larger than or less than the second cross-sectional area. Alternatively, the first cross-sectional area may be equal to the second cross-sectional area.

As provided herein, the one or more channels 158 may be operably coupled with one or more respective supply lines 170 and one or more return lines 172. The supply lines 170 and the return lines 172 may cycle coolant from the coolant source 160 to the manifold assembly 148, and, possibly through the one or more closed-loop engines. Once the coolant flows through the manifold assembly 148, and/or the one or more closed-loop engines, the coolant may be returned to the coolant source 160. In various examples, the coolant source 160 may include a radiator or other thermal component that may alter the temperature of the coolant before returning the coolant to the manifold assembly 148.

Referring still to FIGS. 6-20, in various examples, the manifold assembly 148 may include a coolant reservoir 174. The coolant reservoir 174 may be configured to receive the coolant from a supply line 170. The supply line 170 may be fluidly coupled with a coolant source 160. In some cases, a distributor 176 may be positioned within the coolant reservoir 174. The distributor 176 may be configured to direct the coolant toward one or more supply channels 158 that, in turn, direct the coolant toward each respective engine assembly 100.

With further reference to FIGS. 6-20, in various examples, the manifold assembly 148 may further include a pressure control system 178. For example, a valve assembly 180 may be fluidly coupled with the conduits 146. The valve assembly 180 may include a one-way valve, a check valve, a butterfly valve, or another suitable type of valve configured to open or closed based on a pressure differential, such as between an inlet portion I of the conduit 146 and the outlet portion O of the conduit 146. Stated differently, the valve assembly 180 may be configured to have an opening pressure corresponding to a threshold, above which a portion of the fluid is allowed to flow from the inlet portion/of the conduit 146 to the outlet portion O of the conduit 146.

Referring still to FIGS. 6-20, in several examples, the manifold assembly 148 may further include a sensor system 182. The sensor system 182 may include one or more pressure sensors 184 that may be configured to monitor pressure within a conduit 146, which in turn, may be indicative of a pressure within an associated cylinder. In some cases, the computing system (or an engine controller) may control fuel injection pulses based on the cylinder pressure for improved fuel combustion and reduced fuel consumption. In various cases, by positioning the pressure sensor within the manifold assembly 148, the pressure sensor may be remote from the cylinder thereby reducing the exposure temperature of the pressure sensor compared to the cylinder pressure and/or may be less likely to be contaminated by the fuel in the cylinder.

Referring further to FIGS. 6-20, in some cases, the manifold assembly 148 may include a number of faces 186, which is commensurate with the number of closed-loop engines that are operably coupled with the manifold assembly 148. For example, in cases in which four closed-loop engines 102 are operably coupled with a common manifold assembly 148, the manifold assembly 148 may define four faces 186. In several cases, each face 186 may have an inlet portion I of the first conduit 146, an outlet portion O of the second conduit 146, a first channel 158 configured to transfer coolant from the coolant source 160, and/or a second channel 158 configured to transfer coolant to the coolant source 160. Additionally or alternatively, each face 186 may also include one or more coupling portions 166. For instance, each face 186 may include a first coupling portion 166 positioned laterally outward of the inlet portion I of the first conduit 146, the outlet portion O of the second conduit 146, the first channel 158 configured to transfer coolant from the coolant source 160 to the second closed-cycle engine 102, and/or the second channel 158 configured to transfer coolant from the second closed-cycle engine 102 to the coolant source 160. In addition, each face 186 may include a second coupling portion 166 positioned laterally outward of the inlet portion I of the first conduit 146, the outlet portion O of the second conduit 146, the first channel 158 configured to transfer coolant from the coolant source 160 to the second closed-cycle engine 102, and/or the second channel 158 configured to transfer coolant from the second closed-cycle engine 102 to the coolant source 160 on an opposing side from the first coupling portion 166. In various examples, an engine assembly 100 may be coupled with both the first coupling portion 166 and/or the second coupling portion 166. In some cases, a first fastener may be positioned through the housing 164 of the first closed-cycle engine 102 and into the first coupling portion 166 of the housing 164 of the manifold assembly 148. A second fastener may be positioned through the housing 164 of the first closed-cycle engine 102 and into a second coupling portion 166 of the housing 164 of the manifold assembly 148.

In some examples, the engine assembly 100 may include a first closed-cycle engine 102 including a first piston assembly 112, a second closed-cycle engine 102 including a second piston assembly 112, a third closed-cycle engine 102 including a third piston assembly 112, and/or a fourth closed-cycle engine 102 including a third piston assembly 112. The manifold assembly 148 may define respective faces 186 for each of the number of closed-cycle engines 102. Each face 186 may be configured to operably couple with a respective closed-cycle engine 102. The manifold assembly 148 may include the housing 164. A first conduit 146 may be positioned within the housing 164. The first conduit 146 may be configured to direct a fluid from the first piston assembly 112 to the second piston assembly 112 by transferring fluid from a first inlet portion I₁ to a first outlet portion O₁. Additionally or alternatively, the manifold assembly 148 may include a second conduit 146 positioned within the housing 164. The second conduit 146 may be configured to direct a fluid from the second piston assembly 112 to the third piston assembly 112 by transferring fluid from a second inlet portion I₂ to a second outlet portion O₂. Additionally or alternatively, the manifold assembly 148 may include a third conduit 146 positioned within the housing 164. The third conduit 146 may be configured to direct a fluid from the third piston assembly 112 to the fourth piston assembly 112 by transferring fluid from a third inlet portion I₃ to a third outlet portion O₃. Additionally or alternatively, the manifold assembly 148 may include a fourth conduit 146 positioned within the housing 164. The fourth conduit 146 may be configured to direct a fluid from the fourth piston assembly 112 to the first piston assembly 112 by transferring fluid from a fourth inlet portion I₄ to a fourth outlet portion O₄.

In various examples, the manifold assembly 148, and thus the various components thereof including but not limited to the conduits 146, the channels 158, etc., may be formed via additive manufacturing. As used herein, the term “additive manufacturing” generally refers to a manufacturing technology in which components are manufactured in a layer-by-layer manner. An exemplary additive manufacturing machine may be configured to utilize any suitable additive manufacturing technology. The additive manufacturing machine may utilize an additive manufacturing technology that includes a powder bed fusion (PBF) technology, such as a direct metal laser melting (DMLM) technology, a selective laser melting (SLM) technology, a directed metal laser sintering (DMLS) technology, or a selective laser sintering (SLS) technology. In an exemplary PBF technology, thin layers of powder material are sequentially applied to a build plane and then selectively melted or fused to one another in a layer-by-layer manner to form one or more three-dimensional objects. Additively manufactured objects are generally monolithic in nature and may have a variety of integral sub-components.

Additionally or alternatively suitable additive manufacturing technologies may include, for example, Fused Deposition Modeling (FDM) technology, Direct Energy Deposition (DED) technology, Laser Engineered Net Shaping (LENS) technology, Laser Net Shape Manufacturing (LNSM) technology, Direct Metal Deposition (DMD) technology, Digital Light Processing (DLP) technology, and other additive manufacturing technologies that utilize an energy beam or other energy source to solidify an additive manufacturing material such as a powder material. In fact, any suitable additive manufacturing modality may be utilized with the presently disclosed the subject matter.

Additive manufacturing technology may generally be described as the fabrication of objects by building objects point-by-point, line-by-line, and layer-by-layer, such as in a vertical direction. Other methods of fabrication are contemplated and within the scope of the present disclosure. For example, although the discussion herein refers to the addition of material to form successive layers, the present disclosure may be practiced with any additive manufacturing technology or other manufacturing technology, including layer-additive processes, layer-subtractive processes, or hybrid processes.

The additive manufacturing processes described herein may be used for forming components using any suitable material. For example, the material may be metal, ceramic, polymer, epoxy, photopolymer resin, plastic, or any other suitable material that may be in solid, powder, sheet material, wire, or any other suitable form, or combinations thereof. Additionally, or in the alternative, exemplary materials may include metals, ceramics, or binders, as well as combinations thereof. Exemplary ceramics may include ultra-high-temperature ceramics, and/or precursors for ultra-high-temperature ceramics, such as polymeric precursors. Each successive layer may be, for example, between about 10 micrometers (μm) and 200 μm, although the thickness may be determined based on any number of parameters and may be any suitable size.

As used herein, the term “build plane” refers to a plane defined by a surface upon which an energy beam impinges to selectively irradiate and thereby consolidate powder material during an additive manufacturing process. Generally, the surface of a powder bed defines the build plane. During irradiation of a respective layer of the powder bed, a previously irradiated portion of the respective layer may define a portion of the build plane. Before distributing powder material across a build module, a build plate that supports the powder bed generally defines the build plane.

As used herein, the term “consolidate” or “consolidating” refers to the solidification of powder material as a result of irradiating the powder material, including by way of melting, fusing, sintering, or the like.

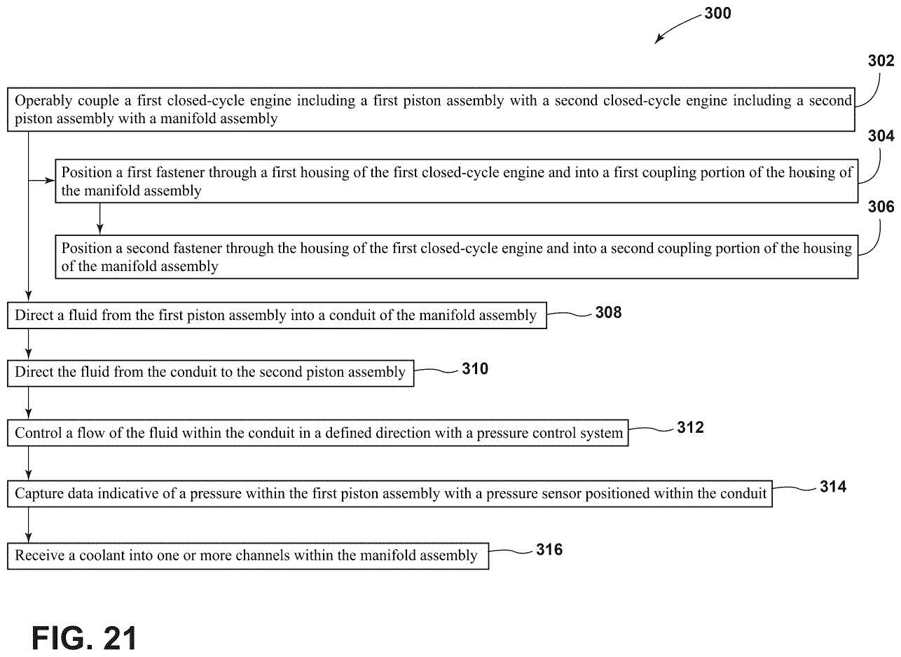

Referring now to FIG. 21, a flow diagram of an embodiment of a method 300 of operating a closed-cycle engine having a cold side and a hot side of a vehicle is illustrated. In general, the method 300 will be described herein with reference to the closed-cycle engine 102 illustrated in FIGS. 1-20. However, it should be appreciated that the disclosed method 300 may be implemented with any engine having any other suitable configurations. In addition, although FIG. 21 depicts steps performed in a particular order for purposes of illustration and discussion, the methods discussed herein are not limited to any particular order or arrangement. One skilled in the art, using the disclosures provided herein, will appreciate that various steps of the methods disclosed herein may be omitted, rearranged, combined, and/or adapted in numerous ways without deviating from the scope of the present disclosure.

As illustrated, at (302), the method 300 may include operably coupling a first closed-cycle engine including a first piston assembly with a second closed-cycle engine including a second piston assembly with a manifold assembly. In various examples, the manifold assembly may be configured to operably coupled with each of the closed-cycle engines thereby maintaining a position of each respective closed-cycle engine relative to one another. At (304), the method may include positioning a first fastener through a first housing of the first closed-cycle engine and into a first coupling portion of the housing of the manifold assembly. Similarly, at (306), the method 300 may include positioning a second fastener through the housing of the first closed-cycle engine and into a second coupling portion of the housing of the manifold assembly.

At (308), the method 300 may include directing a fluid from the first piston assembly into a conduit of the manifold assembly. In addition, at (310), the method 300 may include directing the fluid from the conduit to the second piston assembly.

At (312), the method 300 may include controlling a flow of the fluid within the conduit in a defined direction with a pressure control system. The pressure control system may include a valve assembly. The valve assembly may include a one-way valve, a check valve, a butterfly valve, or another suitable type of valve configured to open or closed based on a pressure differential, such as between an inlet portion of the conduit and the outlet portion of the conduit.

At (314), the method 300 may include capturing data indicative of a pressure within the first piston assembly with a pressure sensor positioned within the conduit.

At (316), the method 300 may include receiving a coolant into one or more channels within the manifold assembly. For instance, in some examples, the manifold assembly may define one or more channels through which a coolant of the cooling system may flow. In several examples, the cooling system may further include a coolant source and a pump for circulating a coolant through the manifold assembly. In some instances, the pump may be integrated with the engine assembly or as a stand-alone component electrically powered by the engine assembly and/or any other power source.

Further aspects are provided by the subject matter of the following clauses:

An engine assembly comprising: a first closed-cycle engine including a first piston assembly; a second closed-cycle engine including a second piston assembly; and a manifold assembly configured to operably couple with the first closed-cycle engine and the second closed-cycle engine, the manifold assembly comprising: a housing; a first conduit positioned within the housing, the first conduit configured to direct a fluid from the first piston assembly to the second piston assembly; and a pressure control system within the first conduit and configured to allow fluid flow in a defined direction.

The engine assembly of one or more of these clauses, further comprising: a cooling system including a coolant source, wherein the manifold assembly further comprises: a first channel configured to transfer coolant from the coolant source to the first closed-cycle engine; and a second channel configured to transfer coolant from the first closed-cycle engine to the coolant source.

The engine assembly of one or more of these clauses, wherein the manifold assembly further comprises: a pressure sensor positioned within the conduit and configured to detect data indicative of a pressure within the first piston assembly.

The engine assembly of one or more of these clauses, wherein the first conduit defines an inlet portion for receiving the fluid from the first piston assembly and an outlet portion for directing the fluid to the second piston assembly.

The engine assembly of one or more of these clauses, wherein the inlet portion defines a first cross-sectional geometric shape and the outlet portion defines a second cross-sectional geometric shape, the first cross-sectional geometric shape varied from the second cross-sectional geometric shape.

The engine assembly of one or more of these clauses, wherein the inlet portion defines a first cross-sectional area and the outlet portion defines a second cross-sectional area, the first cross-sectional area varied from the second cross-sectional area.

The engine assembly of one or more of these clauses, further comprising: a third closed-cycle engine including a third piston assembly, wherein the manifold assembly further comprises: a second conduit positioned within the housing, the second conduit configured to direct a fluid from the second piston assembly to the third piston assembly.

The engine assembly of one or more of these clauses, further comprising: a fourth closed-cycle engine including a fourth piston assembly, wherein the manifold assembly further comprises: a third conduit positioned within the housing, the third conduit configured to direct a fluid from the third piston assembly to the fourth piston assembly; and a fourth conduit positioned within the housing, the fourth conduit configured to direct a fluid from the fourth piston assembly to the first piston assembly.

The engine assembly of one or more of these clauses, wherein the housing defines a face including an inlet portion of the first conduit, an outlet portion of the second conduit, a first channel configured to transfer coolant from the coolant source to the second closed-cycle engine, and a second channel configured to transfer coolant from the second closed-cycle engine to the coolant source.

The engine assembly of one or more of these clauses, wherein the manifold assembly further comprises: a coolant reservoir configured to receive the coolant from a supply line, the supply line fluidly coupled with a coolant source; and a distributor positioned within the coolant reservoir, the distributor configured to direct the coolant toward the first channel.

A method for operating an engine assembly, the method comprising: operably coupling, with a manifold assembly, a first closed-cycle engine including a first piston assembly with a second closed-cycle engine including a second piston assembly; directing a fluid from the first piston assembly into a conduit of the manifold assembly; directing the fluid from the conduit to the second piston assembly; and receiving a coolant into one or more channels within the manifold assembly.

The method of one or more of these clauses, further comprising: controlling, with a pressure control system, a flow of the fluid within the conduit in a defined direction.

The method of one or more of these clauses, further comprising: capturing, with a pressure sensor positioned within the conduit, data indicative of a pressure within the first piston assembly.

The method of one or more of these clauses, further comprising: distributing, via a cooling system, coolant from a coolant source to the one or more channels.

The method of one or more of these clauses, wherein operably coupling the first closed-cycle engine with the second closed-cycle engine further comprises: positioning a first fastener through a first housing of the first closed-cycle engine and into a first coupling portion of the housing of the manifold assembly; and positioning a second fastener through the housing of the first closed-cycle engine and into a second coupling portion of the housing of the manifold assembly.

A manifold assembly configured to operably couple with a first piston assembly and a second piston assembly, the manifold assembly comprising: a housing; a first conduit positioned within the housing, the first conduit configured to direct a fluid from the first piston assembly to the second piston assembly; and a pressure control system within the first conduit and configured to allow fluid flow in a defined direction.

The manifold assembly of one or more of these clauses, further comprising: a first channel configured to transfer coolant from a coolant source to the first piston assembly; and a second channel configured to transfer the coolant from the first piston assembly to the coolant source.

The manifold assembly of one or more of these clauses, further comprising: a distributor positioned within a coolant reservoir, the distributor configured to direct the coolant toward the first channel.

The engine assembly of one or more of these clauses, wherein the manifold assembly further comprises: a pressure sensor positioned within the conduit and configured to detect data indicative of a pressure within the first piston assembly.

The engine assembly of one or more of these clauses, wherein the first conduit defines an inlet portion for receiving the fluid from the first piston assembly and an outlet portion for directing the fluid to the second piston assembly.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

1. An engine assembly comprising:
a first closed-cycle engine including a first piston assembly;
a second closed-cycle engine including a second piston assembly; and
a cooling system including a coolant source;
a manifold assembly configured to operably couple with the first closed-cycle engine and the second closed-cycle engine, the manifold assembly comprising:
a housing;
a first conduit positioned within the housing, the first conduit configured to direct a fluid from the first piston assembly to the second piston assembly; and
a pressure control system within the first conduit and configured to allow fluid flow in a defined direction;
a first channel configured to transfer coolant from the coolant source to the first closed-cycle engine; and
a second channel configured to transfer coolant from the first closed-cycle engine to the coolant source.

2. (canceled)

3. The engine assembly of claim 1, wherein the manifold assembly further comprises:
a pressure sensor positioned within the first conduit and configured to detect data indicative of a pressure within the first piston assembly.

4. The engine assembly of claim 1, wherein the first conduit defines an inlet portion for receiving the fluid from the first piston assembly and an outlet portion for directing the fluid to the second piston assembly.

5. The engine assembly of claim 4, wherein the inlet portion defines a first cross-sectional geometric shape and the outlet portion defines a second cross-sectional geometric shape, the first cross-sectional geometric shape varied from the second cross-sectional geometric shape.

6. The engine assembly of claim 4, wherein the inlet portion defines a first cross-sectional area and the outlet portion defines a second cross-sectional area, the first cross-sectional area varied from the second cross-sectional area.

7. The engine assembly of claim 1, further comprising:
a third closed-cycle engine including a third piston assembly,
wherein the manifold assembly further comprises:
a second conduit positioned within the housing, the second conduit configured to direct a fluid from the second piston assembly to the third piston assembly.

8. The engine assembly of claim 7, further comprising:
a fourth closed-cycle engine including a fourth piston assembly,
wherein the manifold assembly further comprises:
a third conduit positioned within the housing, the third conduit configured to direct a fluid from the third piston assembly to the fourth piston assembly; and
a fourth conduit positioned within the housing, the fourth conduit configured to direct a fluid from the fourth piston assembly to the first piston assembly.

9. The engine assembly of claim 7, wherein the housing defines a face including an inlet portion of the first conduit, an outlet portion of the second conduit, a first channel configured to transfer coolant from the coolant source to the second closed-cycle engine, and a second channel configured to transfer coolant from the second closed-cycle engine to the coolant source. Page

10. The engine assembly of claim 21, wherein the manifold assembly further comprises:
a coolant reservoir configured to receive the coolant from a supply line, the supply line fluidly coupled with the coolant source; and
a distributor positioned within the coolant reservoir, the distributor configured to direct the coolant toward the first channel.

11. A method for operating an engine assembly, the method comprising:
operably coupling, with a manifold assembly including a housing, a first closed-cycle engine including a first piston assembly with a second closed-cycle engine including a second piston assembly;
directing a fluid from the first piston assembly into a conduit of the manifold assembly;
directing the fluid from the conduit to the second piston assembly; and
receiving a coolant into one or more channels within the manifold assembly.

12. The method of claim 11, further comprising:
controlling, with a pressure control system, a flow of the fluid within the conduit in a defined direction.

13. The method of claim 11, further comprising:
capturing, with a pressure sensor positioned within the conduit, data indicative of a pressure within the first piston assembly.

14. The method of claim 11, further comprising:
distributing, via a cooling system, coolant from a coolant source to the one or more channels.

15. The method of claim 13, wherein operably coupling the first closed-cycle engine with the second closed-cycle engine further comprises:
positioning a first fastener through a first housing of the first closed-cycle engine and into a first coupling portion of the housing of the manifold assembly; and
positioning a second fastener through the housing of the first closed-cycle engine and into a second coupling portion of the housing of the manifold assembly.

16. A manifold assembly configured to operably couple with a first piston assembly and a second piston assembly, the manifold assembly comprising:
a housing;
a conduit positioned within the housing, the conduit configured to direct a fluid from the first piston assembly to the second piston assembly, wherein the first piston assembly is positioned within a first closed-cycle engine and the second piston assembly is positioned within a second closed-cycle engine; and
a pressure control system within the conduit and configured to allow fluid flow in a defined direction.

17. The manifold assembly of claim 16, further comprising:
a first channel configured to transfer coolant from a coolant source to the first piston assembly; and
a second channel configured to transfer the coolant from the first piston assembly to the coolant source.

18. The manifold assembly of claim 17, further comprising:
a distributor positioned within a coolant reservoir, the distributor configured to direct the coolant toward the first channel.

19. The manifold assembly of claim 16, wherein the manifold assembly further comprises:
a pressure sensor positioned within the conduit and configured to detect data indicative of a pressure within the first piston assembly.

20. The manifold assembly of claim 16, wherein the conduit defines an inlet portion for receiving the fluid from the first piston assembly and an outlet portion for directing the fluid to the second piston assembly.
